(19) United States
(12) Patent Application Publication
(10) Pub. No.: US 2024/0119107 A1
(43) Pub. Date: Apr. 11, 2024

(54) EVALUATION APPARATUS, EVALUATION METHOD, AND NON-TRANSITORY COMPUTER-READABLE MEDIUM

(71) Applicant: NEC CORPORATION, Minato-ku, Tokyo (JP)

(72) Inventor: Tomoyuki Nishiyama, Tokyo (JP)

(73) Assignee: NEC Corporation, Minato-ku, Tokyo (JP)

(21) Appl. No.: 18/272,966

(22) PCT Filed: Dec. 10, 2021
(86) PCT No.: PCT/JP2021/045477

§ 371 Date: Jul. 18, 2023

(30) Foreign Application Priority Data
Jan. 26, 2021 (JP) 2021-010114

(51) Int. Cl. G06F 17/11; G06F 17/18

(52) U.S. Cl. CPC G06F 17/11; G06F 17/18

(57) ABSTRACT

An evaluation apparatus includes a combination acquisition unit and an evaluation unit. The combination acquisition unit acquires combination determination information from an indicator selection apparatus. The combination determination information determines a combination of a category variable being one of a plurality of indicators related to an evaluation target and at least one support variable each being the indicator different from the category variable. Further, a plurality of groups are determined based on a value of the category variable. Then, a statistic of the support variable is generated for each of the plurality of groups. The evaluation unit generates, for each of the support variables, evaluation information, for example, an evaluation value by using a value of the support variable of the evaluation target and the statistic of the support variable of the group to which the value of the category variable of the evaluation target belongs.

### TECHNICAL FIELD

The present invention relates to an evaluation apparatus, an evaluation method, and a program.

### BACKGROUND ART

In recent years, it has been performed that a relationship between an objective variable and an explanatory variable has been found out by analyzing a great amount of data. On the other hand, as described in Patent Document 1, when a feature value used for a data analysis is generated by taking a combination of a plurality of explanatory variables, the number of the feature values may become too great. In this regard, Patent Document 1 describes that a feature value in which a correlation coefficient with an objective variable is equal to or more than a threshold value is generated.

Further, Patent Document 2 describes that an index value being a degree of co-occurrence in data is computed for each combination of conditions related to a plurality of item values included in the data by using a model that has learned data, and a specific combination is extracted based on the condition or the index value.

### RELATED DOCUMENT

### Patent Document

Patent Document 1: Japanese Patent Application Publication No. 2020-13511
Patent Document 2: Japanese Patent Application Publication No. 2020-140581

### SUMMARY OF INVENTION

### Technical Problem

One of evaluation methods of an evaluation target is a method of evaluation by a plurality of indicators. The present inventor has considered that an evaluation target can be comprehensively evaluated by combining two or more specific indicators among the plurality of indicators. An object of the present invention is to make it easier to accurately evaluate an evaluation target when the evaluation target is evaluated.

### Solution to Problem

The present invention provides an evaluation apparatus including:
a combination acquisition unit that acquires combination determination information that determines a combination of a category variable being one of a plurality of indicators related to an evaluation target and at least one support variable each being the indicator different from the category variable; and
an evaluation unit that generates evaluation information indicating an evaluation result of each of a plurality of the support variables by performing processing using the combination determination information, in which
a plurality of groups are determined based on a value of the category variable, and
the evaluation unit, for each of the support variables,
   acquires a statistic of the support variable of the group to which a value of the category variable of the evaluation target belongs, and
   generates the evaluation information by using the statistic and a value of the support variable of the evaluation target.

The present invention provides an evaluation method including, executing by a computer:
combination acquisition processing of acquiring combination
determination information that determines a combination of a category variable being one of a plurality of indicators related to an evaluation target and at least one support variable each being the indicator different from the category variable; and
evaluation processing of generating evaluation information indicating an evaluation result of each of a plurality of the support variables by performing processing using the combination determination information, in which
a plurality of groups are determined based on a value of the category variable, and
in the evaluation processing, by the computer, for each of the support variables:
   a statistic of the support variable of the group to which a value of the category variable of the evaluation target belongs is acquired; and
   the evaluation information is generated by using the statistic and a value of the support variable of the evaluation target.

The present invention provides a program causing a computer to include:
a combination acquisition function of acquiring combination determination information that determines a combination of a category variable being one of a plurality of indicators related to an evaluation target and at least one support variable each being the indicator different from the category variable; and
an evaluation function of generating evaluation information indicating an evaluation result of each of a plurality of the support variables by performing processing using the combination determination information, in which
a plurality of groups are determined based on a value of the category variable, and
the evaluation function, for each of the support variables,
   acquires a statistic of the support variable of the group to which a value of the category variable of the evaluation target belongs, and
   generates the evaluation information by using the statistic and a value of the support variable of the evaluation target.

### Advantageous Effects of Invention

The present invention can accurately evaluate an evaluation target when the evaluation target is evaluated.

### BRIEF DESCRIPTION OF THE DRAWINGS

FIG. 1 is diagram illustrating a use environment of an indicator selection apparatus and an evaluation apparatus.

FIG. 2 is a diagram illustrating one example of a functional configuration of the indicator selection apparatus.

FIG. 3 is a diagram illustrating one example of data stored in a training data storage unit.

FIG. 4 is a diagram illustrating one example of combination determination information stored in a combination determination information storage unit.

FIG. 5 is a diagram illustrating one example of group determination information stored in the combination determination information storage unit.

FIG. 6 is a diagram illustrating one example of a functional configuration of the evaluation apparatus.

FIG. 7 is a diagram illustrating a first example of data stored in a target data storage unit.

FIG. 8 is a diagram illustrating a second example of data stored in the target data storage unit.

FIG. 9 is a diagram illustrating one example of data output from an output unit.

FIG. 10 is a diagram illustrating a hardware configuration example of the indicator selection apparatus.

FIG. 11 is a flowchart illustrating one example of processing performed by the indicator selection apparatus.

FIG. 12 is a diagram illustrating a modification example of step S110 illustrated in FIG. 11.

FIG. 13 is a flowchart illustrating a first example of processing performed by the evaluation apparatus.

FIG. 14 is a flowchart illustrating details of step S262 in FIG. 13.

FIG. 15 is a diagram illustrating a modification example of FIG. 13.

### DESCRIPTION OF EMBODIMENTS

Hereinafter, example embodiments of the present invention will be described with reference to the drawings. Note that, in all of the drawings, a similar component has a similar reference sign, and description thereof will be appropriately omitted.

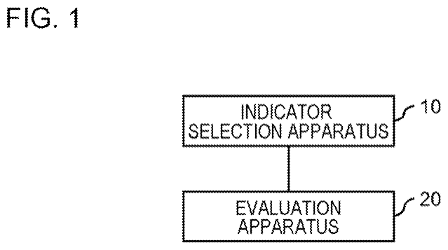

FIG. 1 is diagram illustrating a use environment of an indicator selection apparatus 10 and an evaluation apparatus 20 according to an example embodiment. The evaluation apparatus 20 generates information (hereinafter, described as evaluation information) indicating an evaluation result of an evaluation target. When the evaluation apparatus 20 generates the evaluation information, the evaluation apparatus 20 uses an evaluation model generated by the indicator selection apparatus 10.

Specifically, a state of an evaluation target is indicated by a plurality of indicators. For example, when an evaluation target is a company and an evaluation result indicates soundness (for example, a bankruptcy probability) of the company, each of a plurality of indicators is a financial indicator. Further, when an evaluation target is an individual and an evaluation result is reliability of the individual, at least one of a plurality of indicators is credit information, an income amount, or a deposit amount of the individual.

Then, the evaluation model generated by the indicator selection apparatus generates the evaluation information by using an indicator acquired by combining a category variable and a support variable. Hereinafter, a combination of the category variable and the support variable is described as a combination variable. The category variable and the support variable are both one of the plurality of indicators described above. Specifically, the category variable is a main indicator, and the support variable is an indicator (note that, an indicator different from the category variable) referred to when whether a value of the category variable is good or bad is interpreted. For example, when an evaluation target is a company and a category variable is a safety indicator (for example, a loan dependence rate), one example of a support variable is a profitability indicator (for example, return on assets: ROA).

The number of the category variables used by the evaluation model may be one, but is preferably plural. Note that, the number of the category variables is smaller than the number of the indicators described above. Then, one or more support variables (preferably, a plurality of support variables) are set for one category variable.

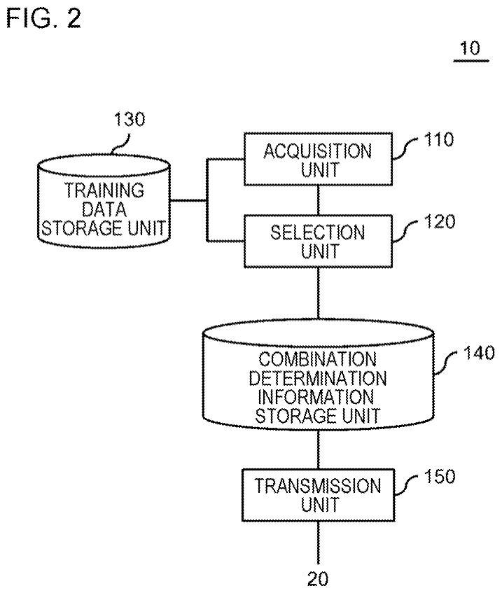

FIG. 2 is a diagram illustrating one example of a functional configuration of the indicator selection apparatus 10. The indicator selection apparatus 10 includes an acquisition unit 110 and a selection unit 120, and generates at least one (preferably, plural) combination variable described above.

The acquisition unit 110 acquires information (hereinafter, described as category variable specification information) that specifies a category variable.

The acquisition unit 110 may acquire the category variable specification information from the outside of the indicator selection apparatus 10, or may generate the category variable specification information by processing data. In the former case, the acquisition unit 110 may acquire the category variable specification information by a user input, or may acquire the category variable specification information by communication. In the latter case, the acquisition unit 110 generates the category variable specification information by using data stored in a training data storage unit 130 described below, for example.

The selection unit 120 selects a support variable from among the plurality of indicators described above for each category variable. In other words, the selection unit 120 selects at least one (preferably, plural) combination variable, and sets information (hereinafter, described as combination determination information) that determines the selected combination variable. Specifically, the selection unit 120 generates a first model by performing machine learning by using the combination variable described above as an explanatory variable and using an evaluation result of an evaluation target as an objective variable. One example of a technique used herein is XGboost or dotDATA. Then, a first influence degree is generated for each of a plurality of the combination variables. The first influence degree indicates magnitude of an influence of the combination variable on accuracy of the first model. Then, the selection unit 120 selects a support variable by using the first influence degree. For example, the selection unit 120 selects a necessary number of the support variables in descending order of the first influence degree. One example of the first influence degree is Feature Importance.

Note that, the selection unit 120 may generate combination determination information by selecting a combination variable in which a first influence degree satisfies a reference from among a plurality of combination variables without selecting a support variable for each category variable. One example of the reference used herein is a “first influence degree greater than a reference value”, but may be a “first influence degree within a predetermined place in ranking when counted from the top”.

In the example illustrated in FIG. 2, the indicator selection apparatus 10 further includes the training data storage unit 130, a combination determination information storage unit 140, and a transmission unit 150.

The training data storage unit 130 stores training data for generating a first model. The selection unit 120 generates the first model by using the training data stored in the training data storage unit 130, and also generates a first influence degree for each of the plurality of combination variables.

Note that, as described above, the training data use a combination variable as an explanatory variable, and use an evaluation result of an evaluation target as an objective variable. The training data storage unit 130 only has to store data (for example, a value of each of a plurality of indicators) needed to generate a combination variable, and an evaluation result even without storing training data themselves. In this case, the selection unit 120 generates training data by using the data stored in the training data storage unit 130.

The combination determination information storage unit 140 stores the combination determination information described above. The combination determination information is information indicating an evaluation model used by the evaluation apparatus 20.

Note that, as details will be described below, a plurality of groups are determined according to a value of a category variable. Then, the evaluation apparatus 20 changes an evaluation method of an evaluation target depending on a group to which the evaluation target belongs. The combination determination information storage unit 140 also stores information (hereinafter, described as group determination information) that determines the groups.

The transmission unit 150 transmits the combination determination information and the group determination information stored in the combination determination information storage unit 140 to the evaluation apparatus 20.

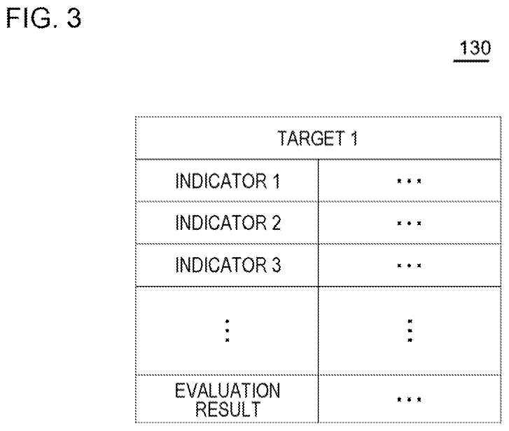

FIG. 3 is a diagram illustrating one example of data stored in the training data storage unit 130. As described above, the training data storage unit 130 stores training data or information being a source of the training data. In the example illustrated in FIG. 3, the training data storage unit 130 stores a plurality of data sets being a source of the training data. FIG. 3 illustrates one data set. As illustrated in FIG. 3, each of a plurality of data sets includes a value of each of a plurality of indicators and an evaluation result. One data set is actual data related to a target of the same kind as an evaluation target. For example, when an evaluation target is a company, one data set includes, in a certain company, a value of each of a plurality of financial indicators (corresponding to a value of each of a plurality of indicators) and data (corresponding to a value of an evaluation result) indicating by a binary whether the company went bankrupt a predetermined period after. Further, when an evaluation target is an individual, one data set includes, in a certain individual, a value of each of a plurality of indicators included in credit information and a value indicating reliability (corresponding to a value of an evaluation result).

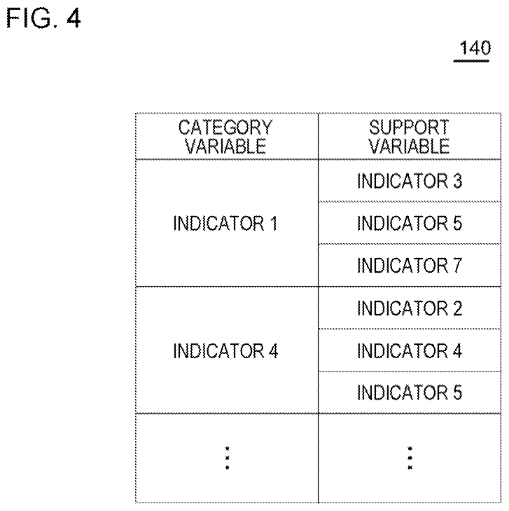

FIG. 4 is a diagram illustrating one example of combination determination information stored in the combination determination information storage unit 140. The combination determination information includes information indicating an indicator being a category variable, and information indicating an indicator being a support variable of the category variable. Herein, a plurality of support variables may be specified for one category variable. Further, when there are a plurality of category variables, the combination determination information includes information indicating, for each category variable, an indicator being a support variable of the category variable.

Further, when there are a plurality of kinds of evaluation targets, the combination determination information storage unit 140 stores combination determination information for each of the kinds. For example, the combination determination information storage unit 140 stores combination determination information for evaluating a company and combination determination information for evaluating an individual.

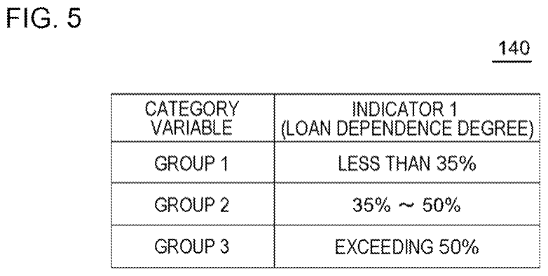

FIG. 5 is a diagram illustrating one example of group determination information stored in the combination determination information storage unit 140. As described above, a plurality of groups are determined according to a value of a category variable. The group determination information stores information indicating, for each group, a range of a value being a definition of the group. When a plurality of category variables are set, the combination determination information 140 stores group determination information for each of the plurality of category variables.

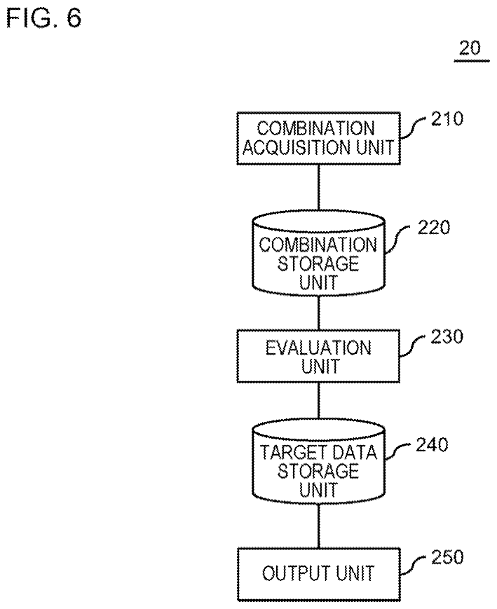

FIG. 6 is a diagram illustrating one example of a functional configuration of the evaluation apparatus 20. The evaluation apparatus 20 includes a combination acquisition unit 210 and an evaluation unit 230.

The combination acquisition unit 210 acquires combination determination information and group determination information from the indicator selection apparatus 10, and stores the combination determination information and the group determination information in a combination storage unit 220. The combination storage unit 220 may be a part of the evaluation apparatus 20, or may be located outside the evaluation apparatus 20.

The evaluation unit 230 generates information indicating an evaluation result of each of a plurality of support variables, i.e., the evaluation information described above by performing processing using the combination determination information and the group determination information stored in the combination storage unit 220.

Specifically, as described above, a plurality of groups are determined based on a value of a category variable. Then, a statistic of a support variable is generated for each of the plurality of groups. The statistic is generated with, as a population, evaluation targets in which the value of the category variable belongs to the group. The statistic is, for example, an average value of the support variables, but may be a value based on another statistical technique. Then, the evaluation unit 230 generates, for each of the support variables, evaluation information, for example, an evaluation value by using a value of the support variable of the evaluation target and the statistic of the support variable of the group to which the value of the category variable of the evaluation target belongs. One example of the evaluation value is a standardized value.

Hereinafter, a case where an evaluation target is a company, an evaluation result is a bankruptcy probability, and a category variable and a support variable are financial indicators is used as an example.

Each of a plurality of groups is defined as a range of a value of a financial indicator specified by a category variable. For example, in the example illustrated in FIG. 5, a plurality of groups are defined by a value of a loan dependence degree. Further, for each of category variables, a plurality of financial indicators are specified as support variables. The evaluation unit 230 acquires a value (for example, a value of a loan dependence degree) of a financial indicator which is specified as a category variable among values of a plurality of financial indicators of an evaluation target, and determines a group (i.e., a group to which the evaluation target belongs) including the value. For example, when group determination information is the example illustrated in FIG. 5 and a loan dependence degree of a company being an evaluation target is 40%, the evaluation target belongs to group 2. Then, the evaluation unit 230 acquires a statistic of each of a plurality of financial indicators specified as support variables with, as a population, a plurality of companies having a loan dependence degree greater than 35% and equal to or less than 50%.

Further, the evaluation unit 230 acquires a value of each of a plurality of financial indicators specified as support variables among values of a plurality of financial indicators of an evaluation target. Then, by using a statistic of each of a plurality of support variables (financial indicators) in a specified group and a value of each of a plurality of support variables (financial indicators) in an evaluation target, the evaluation unit 230 generates an evaluation value of each of the plurality of support variables.

Note that, when a plurality of sets of combinations of a category variable and a plurality of support variables are specified in combination determination information, the evaluation unit 230 generates, for each of a plurality of the category variables, evaluation information for each of a plurality of the support variables.

Details of processing performed by the evaluation unit 230 will be described below by using a flowchart.

Note that, the evaluation unit 230 acquires information about an evaluation target from a target data storage unit 240. Further, the evaluation unit 230 stores generated evaluation information in association with the evaluation target in the target data storage unit 240. The target data storage unit 240 may be a part of the evaluation apparatus 20, or may be located outside the evaluation apparatus 20.

Further, the evaluation apparatus 20 includes an output unit 250. The output unit 250 generates output information by using evaluation information, and outputs the output information. An output destination of the output information may be a display or may be a printing apparatus. As described above, a category variable is a main indicator, and a support variable is an indicator referred to when whether a value of the category variable is good or bad is interpreted. The output information includes information (for example, a name of a financial indicator) indicating a kind of a category variable, a value of the category variable (for example, a value of the financial indicator), information (for example, a name of a financial indicator) indicating a kind of a support variable, a value of the support variable (for example, a value of the financial indicator), and evaluation information about a combination of the category variable and the support variable.

Note that, as described above, a plurality of support variables are associated with one category variable. Thus, when information about all combinations of a category variable and a support variable (i.e., all combination variables) is included in output information, an information amount is too great. Thus, the output unit 250 selects information about a combination variable in which at least a support variable satisfies a predetermined reference (hereinafter, described as a first reference), and includes the information in the output information. The first reference is that, for example, when ranking is performed on a plurality of combination variables, based on evaluation information (for example, ranking based on magnitude of an evaluation value), the place in ranking is within a first predetermined place from the top or within a second predetermined place from the bottom. The predetermined places may be a predetermined place being a third or higher place (including a first place), or may be a predetermined place being a fifth or higher place. Further, the first predetermined place and the second predetermined place may be the same or may be different. The predetermined places may be set for each category variable.

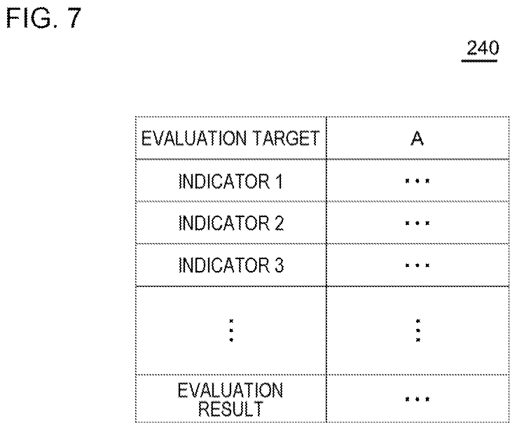

FIG. 7 is a diagram illustrating a first example of data stored in the target data storage unit 240. As described above, the target data storage unit 240 stores information about an evaluation target. Specifically, the target data storage unit 240 stores, for each evaluation target, a value of each indicator of the evaluation target. A kind of each indicator stored herein is the same as a kind of each indicator stored in the training data storage unit 130. For example, when an evaluation target is a company, each indicator stored in the target data storage unit 240 is a financial indicator. Further, when an evaluation target is an individual, each indicator stored in the target data storage unit 240 is an indicator included in credit information.

Note that, the target data storage unit 240 stores a value of each indicator of each of a plurality of evaluation targets. The values are used when the evaluation unit 230 computes the statistic described above. However, the statistic described above may be computed by using a value of each indicator of a target other than an evaluation target being a processing target of the evaluation unit 230. For example, the statistic described above may be computed by using a financial indicator of a company other than a company being an evaluation target, or may be computed by using credit information about an individual other than an individual being an evaluation target. In these cases, the statistic described above may be further computed by further using a statistic of an evaluation target stored in the target data storage unit 240.

Further, the target data storage unit 240 may further store the statistic described above itself. In this case, the evaluation unit 230 reads a value of each indicator of an evaluation target from the target data storage unit 240, and also reads the statistic.

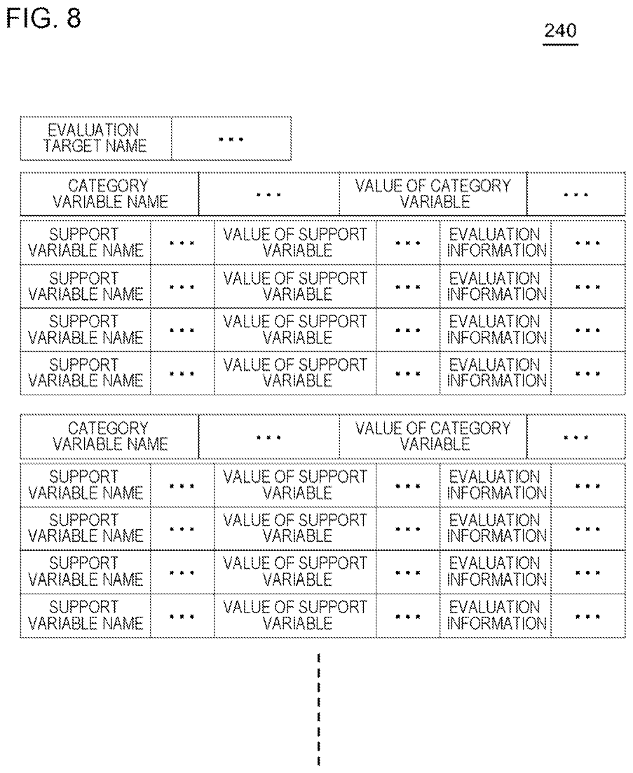

FIG. 8 is a diagram illustrating a second example of data stored in the target data storage unit 240. As described above, the target data storage unit 240 stores evaluation information generated by the evaluation unit 230. Specifically, the target data storage unit 240 stores, for each evaluation target, evaluation information for each combination of a category variable and a support variable (i.e., for each combination variable). Herein, the target data storage unit 240 preferably stores evaluation information about all combination variables.

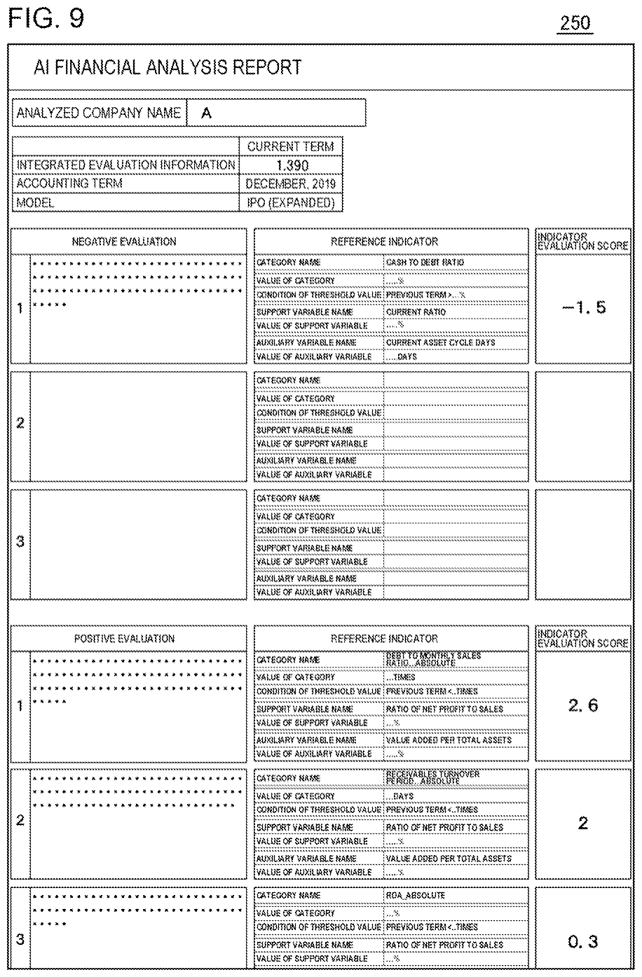

FIG. 9 is a diagram illustrating one example of data output from the output unit 250. In the example illustrated in FIG. 9, the output unit 250 outputs information about a specific combination variable in a certain evaluation target. The information to be output includes, in addition to evaluation information (described as an indicator evaluation score in FIG. 9) about the combination variable, a category variable name (described as “category name” in FIG. 9) constituting the combination variable, a value (described as “value of category” in FIG. 9) of the category variable, a support variable name constituting the combination variable, and a value of the support variable. Furthermore, in the example in FIG. 9, the output unit 250 also outputs information (described as “condition of threshold value” in the example illustrated in FIG. 9) indicating which group the evaluation target belongs to in relation to the category variable.

Further, the output unit 250 outputs a sentence indicating an interpretation result of a combination variable. The sentence is generated by using a model that outputs a sentence with, as an input, evaluation information about a combination variable, a category variable name constituting the combination variable, a value of the category variable, a support variable name constituting the combination variable, and a value of the support variable, for example. The model may be generated by using machine learning. Note that, the sentence may be input by a person who views the result illustrated in FIG. 9.

Note that, in the example illustrated in FIG. 9, the output unit 250 outputs auxiliary evaluation information for each combination variable. The auxiliary evaluation information is generated by the evaluation unit 230 and also stored in the target data storage unit 240. The evaluation unit 230 sets a support variable as a second category variable, and sets, as second support variables, a plurality of indicators different from the category variable and the support variable constituting the combination variable. Then, by performing, on a combination of the second category variable and the second support variables, processing similar to the processing on the combination variable described above, evaluation information about the second support variables is generated as the auxiliary evaluation information described above. The second support variables are indicators referred to when whether a value of the support variable is good or bad is interpreted. Then, the output unit 250 selects, for each combination variable, a second support variable having a highest degree of the auxiliary evaluation information (for example, having a highest evaluation value), and outputs a name of the second support variable (described as “auxiliary variable name” in FIG. 9) together with a value of the second support variable (described as “value of auxiliary variable” in FIG. 9). Herein, furthermore, the output unit 250 may further output evaluation information about the second support variable.

For example, a case where an evaluation target is a company, a category variable is a loan dependence degree, a support variable is a tangible fixed asset cycle turnover, and a second support variable is a liquidity ratio is assumed. When the loan dependence degree is, for example, 25% and the tangible fixed asset cycle turnover is five times, it is generally determined that profitability is sufficiently high although a loan is small. Herein, when the liquidity ratio is, for example, 300% and high, it can be interpreted that there is a low possibility of financial difficulty in a short term. On the other hand, when the liquidity ratio is, for example, 100% and low, it can be said that necessary working funds cannot be secured, and thus it can be interpreted that there is a possibility of seemingly high profitability due to a nonperforming loan and dead stock. Note that, even in this case, when trade receivables and a total stock have no problem, for example, it may be determined that cash temporarily runs short and a small loan is a good state.

Note that, the evaluation unit 230 may not generate the auxiliary evaluation information.

Further, since there are many kinds of combination variables, the output unit 250 selects, as a combination variable whose information needs to be output, a combination variable that satisfies a first reference as described above. As one example, when ranking is performed on a plurality of combination variables, based on evaluation information, the output unit 250 selects a combination variable within a first predetermined place from the top and also selects a combination variable within a second predetermined place from the bottom. Then, the output unit 250 outputs the information described above about the selected combination variable.

Note that, when there is a predetermined input (for example, an input indicating that evaluation information about another combination variable is desired to be checked), the output unit 250 also outputs information about a support variable whose evaluation information does not satisfy the first reference similar to the information about a support variable whose evaluation information satisfies the first reference.

Further, it is preferable that the output unit 250 selects, for each of a plurality of category variables, a support variable whose evaluation information satisfies a second reference, and sets the selected support variable and the category variable as a candidate for a combination variable needed to be output from the output unit 250. In this case, the output unit 250 selects a combination variable needed to be output from among the selected candidates.

As described above, a support variable is an indicator referred to when whether a value of a category variable is good or bad is interpreted. Thus, when a support variable that disagrees with the interpretation is selected, there is a possibility that confusion may occur in the interpretation of the category variable. Thus, the second reference is set in order to provide uniformity to a support variable to be selected. For example, when evaluation information is a standardized value, the second reference is that whether the evaluation information is positive or negative is the same as that of a support variable having the greatest absolute value of the standardized value. For example, when a standardized value of a support variable having the greatest absolute value of the standardized value is a negative value, the second reference is “evaluation information is negative”.

Further, as another example of the second reference, the second reference is that the same indicator is not used as a support variable for a predetermined number of times or more (for example, three times or more) when a plurality of combination variables are viewed as a whole. The reason is that, when a certain indicator has an abnormal value, a possibility that the indicator is repeatedly selected as a support variable is increased, and an evaluation of an evaluation target is greatly affected by the abnormal value.

Further, the evaluation unit 230 generates information (hereinafter, described as integrated evaluation information) indicating a comprehensive evaluation result of an evaluation target by using an evaluation result of each of a plurality of combination variables. For example, when an evaluation result of each of a plurality of combination variables has a score, integrated evaluation information is a result of performing statistical processing on the scores. For example, when an evaluation result of each combination variable includes a standardized value, integrated evaluation information is generated by adding all the standardized values.

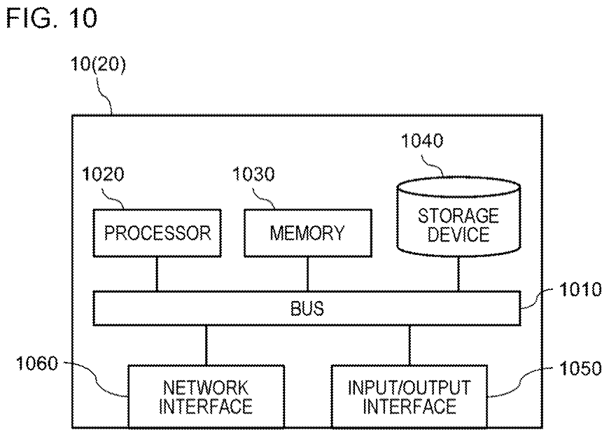

FIG. 10 is a diagram illustrating a hardware configuration example of the indicator selection apparatus 10. The indicator selection apparatus 10 includes a bus 1010, a processor 1020, a memory 1030, a storage device 1040, an input/output interface 1050, and a network interface 1060.

The bus 1010 is a data transmission path for allowing the processor 1020, the memory 1030, the storage device 1040, the input/output interface 1050, and the network interface 1060 to transmit and receive data with one another. However, a method for connecting the processor 1020 and the like to one another is not limited to bus connection.

The processor 1020 is a processor achieved by a central processing unit (CPU), a graphics processing unit (GPU), and the like.

The memory 1030 is a main storage achieved by a random access memory (RAM) and the like.

The storage device 1040 is an auxiliary storage achieved by a hard disk drive (HDD), a solid state drive (SSD), a memory card, a read only memory (ROM), or the like. The storage device 1040 stores a program module that achieves each function (for example, the acquisition unit 110, the selection unit 120, and the transmission unit 150) of the indicator selection apparatus 10. The processor 1020 reads each program module onto the memory 1030 and executes the program module, and thereby each function associated with the program module is achieved. Further, the storage device 1040 also functions as the training data storage unit 130 and the combination determination information storage unit 140.

The input/output interface 1050 is an interface for connecting the indicator selection apparatus 10 and various types of input/output equipment.

The network interface 1060 is an interface for connecting the indicator selection apparatus 10 to a network. The network is, for example, a local area network (LAN) and a wide area network (WAN). A method of connection to the network by the network interface 1060 may be wireless connection or wired connection. The indicator selection apparatus 10 may communicate with the evaluation apparatus 20 via the network interface 1060.

Note that a hardware configuration of the evaluation apparatus 20 is also similar to the hardware configuration of the indicator selection apparatus 10 illustrated in FIG. 10. Then, the storage device 1040 stores a program module that achieves each function (for example, the combination acquisition unit 210, the evaluation unit 230, and the output unit 250) of the evaluation apparatus 20. Further, the storage device 1040 also functions as the combination storage unit 220 and the target data storage unit 240.

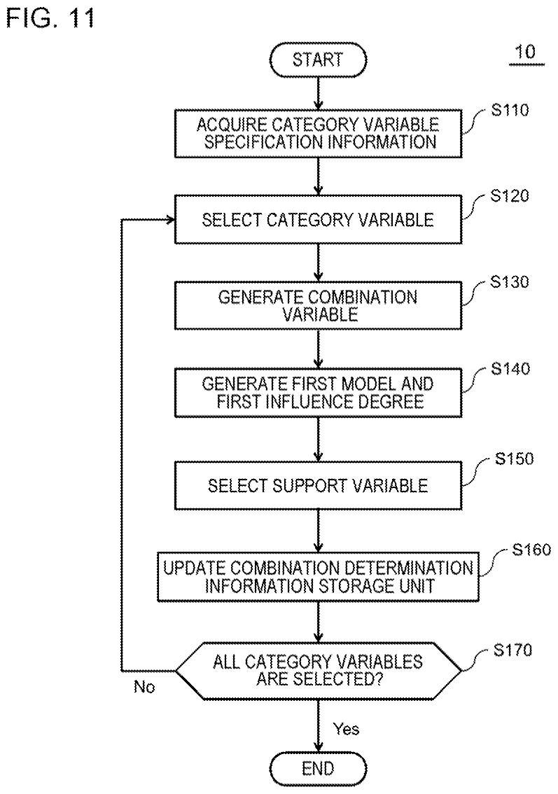

FIG. 11 is a flowchart illustrating one example of processing performed by the indicator selection apparatus 10. First, the acquisition unit 110 of the indicator selection apparatus 10 acquires category variable specification information from the outside of the indicator selection apparatus 10 (step S110). For example, when there are 200 kinds of indicators, the number of category variables specified by the category variable specification information is preferably equal to or less than 50.

Then, the selection unit 120 selects one of the category variables specified by the category variable specification information (step S120). Then, the selection unit 120 generates a plurality of combination variables by using the selected category variable (step S130). The number of the combination variables generated herein is “number of indicators used—1”. For example, when there are 200 kinds of indicators, the number of the combination variables generated herein is 199.

Then, the selection unit 120 generates the first model described above by using the plurality of combination variables, and also generates the first influence degree described above for each of the plurality of combination variables (step S140). Then, the selection unit 120 selects a support variable for the category variable selected in step S120 by using the first influence degree (step 150). In this way, the combination variable is selected. Then, the selection unit 120 stores information indicating the selected combination variable as combination determination information in the combination determination information storage unit 140 (step S160).

The indicator selection apparatus 10 performs the processing indicated in step S130 to step S160 on all category variables indicated by the category variable specification information (step S170 and step S120).

Note that, the selection unit 120 may perform the processing indicated in step S150 and step S160 after step S170. In this case, the selection unit 120 generates combination determination information by computing a first influence degree for all combination variables, and then selecting a predetermined number of the combination variables in descending order of the first influence degree. Then, combination information is stored in the combination determination information storage unit 140. In this case, the number of support variables may vary for each category variable. For example, there may be a category variable in which a plurality of support variables are selected and a category variable in which no support variable is selected at all. Further, in this case, combination variables may be further narrowed down in consideration of multicollinearity. For example, the narrowing may be performed by a person or may be performed by the selection unit 120.

Further, in addition to the processing illustrated in FIG. 11, the indicator selection apparatus 10 generates group determination information, and stores, in advance, the generated group determination information in the combination determination information storage unit 140. Subsequently, the transmission unit 150 of the indicator selection apparatus 10 transmits the combination determination information and the group determination information to the evaluation apparatus 20 at a predetermined timing.

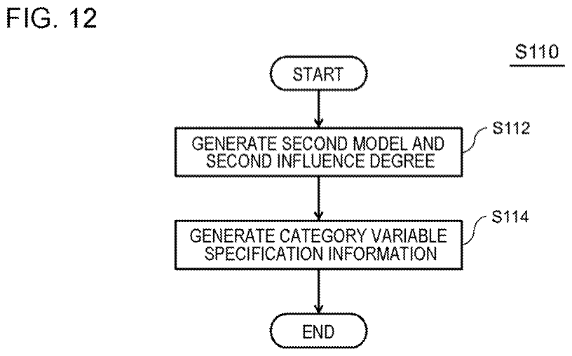

FIG. 12 is a diagram illustrating a modification example of step S110 illustrated in FIG. 11. In the present modification example, the acquisition unit 110 generates category variable specification information by processing information stored in the training data storage unit 130.

Specifically, the acquisition unit 110 generates a second model by using data stored in the training data storage unit 130. The second model is generated by performing machine learning by using a plurality of indicators as explanatory variables and using an evaluation result as an objective variable. One example of a technique used herein is XGboost or dotDATA. Further, the acquisition unit 110 generates a second influence degree for each of a plurality of indicators. The second influence degree is, for example, Feature Importance, and indicates magnitude of an influence of the indicator on accuracy of the second model (step S112).

Then, the acquisition unit 110 selects a category variable from among the plurality of indicators by using the second influence degree. For example, the acquisition unit 110 selects, as a category variable, a predetermined number of indicators in descending order of the second influence degree (step S114).

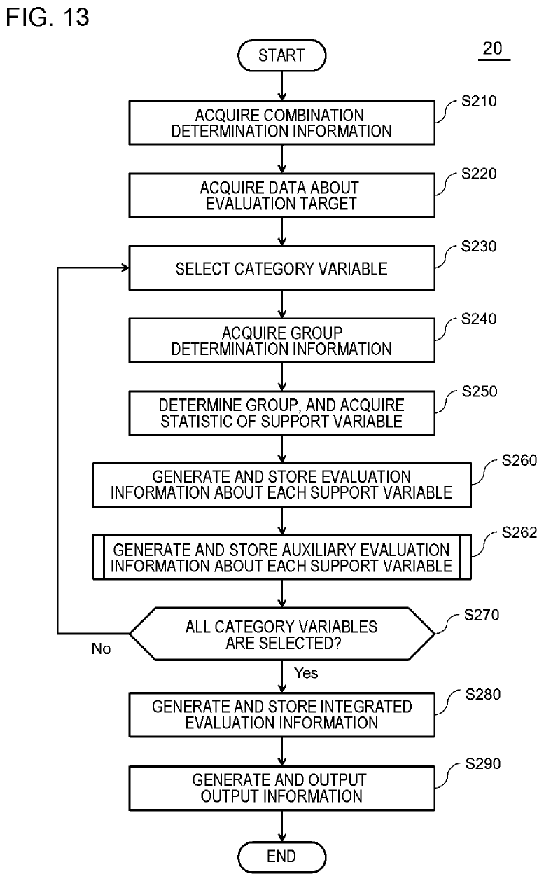

FIG. 13 is a flowchart illustrating a first example of processing performed by the evaluation apparatus 20. The processing illustrated in FIG. 13 is processing for evaluating an evaluation target. Then, before the processing, the combination acquisition unit 210 of the evaluation apparatus 20 acquires combination determination information and group determination information from the indicator selection apparatus 10, and stores the combination determination information and the group determination information in the combination storage unit 220.

First, the evaluation unit 230 reads combination determination information from the combination storage unit 220 (step S210). The combination determination information indicates a category variable and a support variable used in the category variable. Further, the evaluation unit 230 reads data about each indicator of an evaluation target from the target data storage unit 240 (step S220). Then, the evaluation unit 230 performs processing indicated in step S240 to step S262 on each of a plurality of category variables indicated by the combination determination information (step S230 and step S270).

First, the evaluation unit 230 selects one category variable from among a plurality of category variables indicated by the combination determination information (step S230). By the selection, a plurality of indicators needed to be used as support variables are also determined. Then, the evaluation unit 230 reads group determination information about the selected category variable from the combination storage unit 220 (step S240). Then, the evaluation unit 230 determines a group to which a value of the category variable of the evaluation target belongs by using the group determination information. Then, the evaluation unit 230 acquires a statistic of each support variable in the group (step S250). Then, the evaluation unit 230 generates evaluation information about each support variable by using the statistic and a value of each support variable of the evaluation target, and stores the evaluation information in the target data storage unit 240 (step S260).

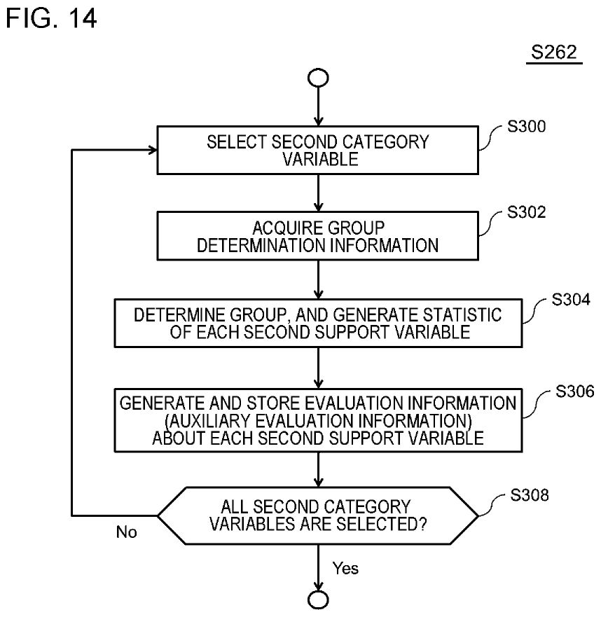

Further, the evaluation unit 230 generates auxiliary evaluation information about each support variable, and stores the auxiliary evaluation information in the target data storage unit 240 (step S262). Details of Step S262 will be described below by using FIG. 14.

Then, the evaluation unit 230 generates integrated evaluation information, and stores the integrated evaluation information in the target data storage unit 240 (step S280). Subsequently, the output unit 250 generates output information (for example, screen data and/or printing data), and outputs the output information (step S290).

FIG. 14 is a flowchart illustrating details of step S262 in FIG. 13. The evaluation unit 230 performs processing indicated in step S302 to step S306 on each of a plurality of support variables (i.e., a plurality of second category variables) (step S300 and step S308).

First, the evaluation unit 230 selects one support variable (second category variable) (step S300). By the selection, a plurality of indicators needed to be used as second support variables are also determined. Then, the evaluation unit 230 reads group determination information about the selected second category variable from the combination storage unit 220 (step S302). Then, the evaluation unit 230 determines a group to which a value of the second category variable of the evaluation target belongs by using the group determination information. Then, the evaluation unit 230 acquires a statistic of each second support variable in the group (step S304). Then, the evaluation unit 230 generates evaluation information (i.e., auxiliary evaluation information) about each second support variable by using the statistic and a value of each second support variable of the evaluation target, and stores the evaluation information in the target data storage unit 240 (step S306).

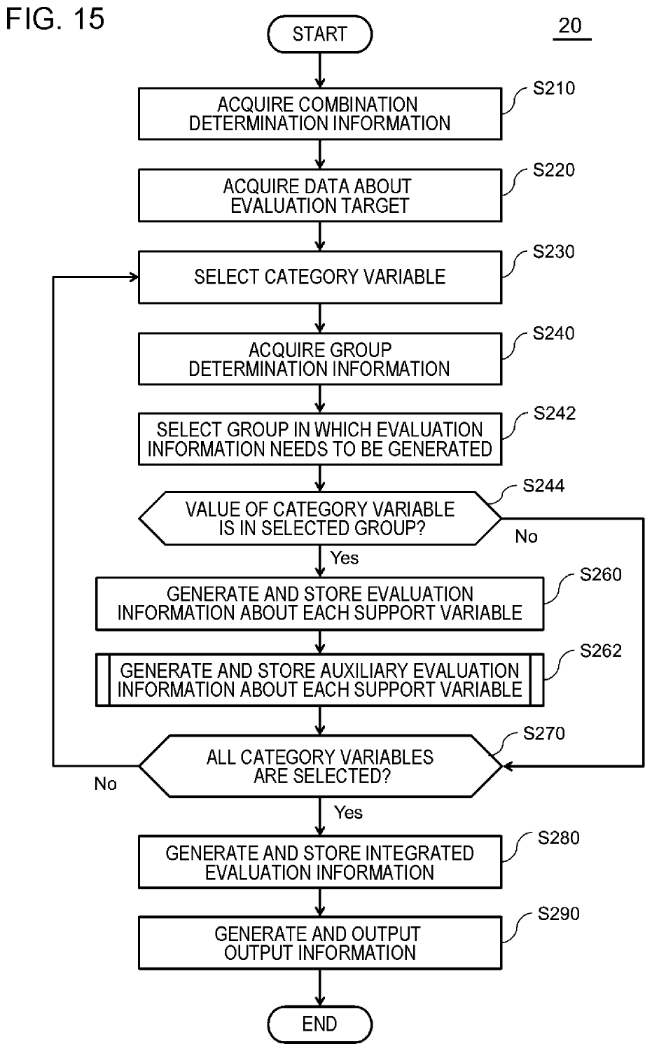

FIG. 15 is a diagram illustrating a modification example of FIG. 13. As to a group that satisfies a third reference, the present modification example is similar to that in the example illustrated in FIG. 14 except for a point that evaluation information about a support variable is not generated.

Specifically, after the evaluation unit 230 acquires group information (step S240), the evaluation unit 230 selects the group information that does not satisfy a third reference as a group in which evaluation information needs to be generated (step S242) before the evaluation unit 230 computes a statistic of a support variable (step S250). Then, only when a value of the category variable of the evaluation target belongs to the group selected in step S242 (step S244: Yes), the evaluation unit 230 performs processing indicated in steps S260 and S262.

The third reference indicates that, for example, the group has a standard value of the category variable. When a value of the category variable of the evaluation target belongs to the group that satisfies the third reference, the evaluation target is standard for the category variable, and thus an evaluation result of the evaluation target is not greatly affected. Thus, for the group that satisfies the third reference, the evaluation result of the evaluation target hardly changes even when the evaluation information about the support variable is not generated. Note that, one example of the third reference is that the group includes at least one of a mode, a medium value, and an average value of category variables.

Note that, when a value of the category variable of the evaluation target does not belong to the group selected in step S242 (step S244: No), the evaluation unit 230 may assign a fixed value as an evaluation value of the support variable in step S260. The fixed value is a standard value (for example, an average value, a medium value, or a mode) as an evaluation value.

As described above, by using the indicator selection apparatus 10, the present example embodiment makes it easier to select two indicators that need to be combined when an evaluation target is evaluated. Further, the evaluation apparatus 20 generates evaluation information for each of the two indicators (i.e., a combination variable) selected by the indicator selection apparatus 10 for the evaluation target. Therefore, a user of the evaluation apparatus 20 easily accurately evaluates the evaluation target by reviewing the evaluation information.

While the example embodiments of the present invention have been described with reference to the drawings, the example embodiments are only exemplification of the present invention, and various configurations other than the above-described example embodiments can also be employed.

Further, the plurality of steps (pieces of processing) are described in order in the plurality of flowcharts used in the above-described description, but an execution order of steps performed in each of the example embodiments is not limited to the described order. In each of the example embodiments, an order of illustrated steps may be changed within an extent that there is no harm in context. Further, each of the example embodiments described above can be combined within an extent that a content is not inconsistent.

A part or the whole of the above-described example embodiment may also be described in supplementary notes below, which is not limited thereto.
1. An evaluation apparatus including:
   a combination acquisition unit that acquires combination determination information that determines a combination of a category variable being one of a plurality of indicators related to an evaluation target and at least one support variable each being the indicator different from the category variable; and
   an evaluation unit that generates evaluation information indicating an evaluation result of each of a plurality of the support variables by performing processing using the combination determination information, in which
   a plurality of groups are determined based on a value of the category variable, and
   the evaluation unit, for each of the support variables,
      acquires a statistic of the support variable of the group to which a value of the category variable of the evaluation target belongs, and
      generates the evaluation information by using the statistic and a value of the support variable of the evaluation target.
2. The evaluation apparatus according to supplementary note 1 described above, in which
   the combination determination information specifies the at least one support variable for each of a plurality of the category variables, and
   the evaluation unit generates the evaluation information for each of the category variables.
3. The evaluation apparatus according to supplementary note 1 or 2 described above, in which
   the statistic is an average value, and
   the evaluation information is a value acquired by standardizing a value of the support variable of the evaluation target.
4. The evaluation apparatus according to any one of supplementary notes 1 to 3 described above, further including
   an output unit that outputs, together with the category variable, the support variable in which the evaluation information satisfies a first reference.
5. The evaluation apparatus according to supplementary note 4 described above when dependent on supplementary note 2 described above, in which
   the evaluation unit generates an evaluation value as the evaluation information for each combination of the category variable and the support variable, and
   the output unit selects and outputs a combination of the category variable and the support variable in which the evaluation value satisfies the first reference.
6. The evaluation apparatus according to supplementary note 5 described above, in which
   places of a plurality of the combinations in ranking are decided according to the evaluation value,
   the first reference is that the place in ranking is positioned within a first predetermined place when counted from a top, and that the place in the ranking is positioned within a second predetermined place when counted from a bottom, and
   the output unit outputs each of the combination positioned within the first predetermined place and the combination positioned within the second predetermined place.
7. The evaluation apparatus according to supplementary note 5 or 6 described above, in which
   the output unit
      selects, for each of a plurality of the category variables, the support variable in which the evaluation information satisfies a second reference, and sets the selected support variable and the category variable as a candidate for the combination, and
      selects the combination needed to be output from among the candidates.
8. The evaluation apparatus according to any one of supplementary notes 4 to 7 described above, in which
   the output unit further outputs the evaluation information.
9. The evaluation apparatus according to any one of supplementary notes 4 to 8 described above, in which
   the output unit outputs the support variable in which the evaluation information does not satisfy a first reference when there is a predetermined input.
10. The evaluation apparatus according to any one of supplementary notes 1 to 9 described above, in which
   the evaluation unit does not generate the evaluation information or assigns the evaluation information being fixed, for the group that satisfies a third reference.
11. The evaluation apparatus according to supplementary note 10 described above, in which
   the third reference is that the group includes at least one of a mode, a medium value, and an average value of the category variables.
12. The evaluation apparatus according to any one of supplementary notes 1 to 11 described above, in which
   at least one support variable is selected for a plurality of the category variables, and
   the evaluation unit
      generates the evaluation information for each combination of the category variable and the support variable, and
      generates comprehensive evaluation information indicating an evaluation result of the evaluation target by using the plurality of pieces of the evaluation information.
13. The evaluation apparatus according to any one of supplementary notes 1 to 12 described above, in which
   the evaluation unit, for each of a plurality of the support variables,
      sets the support variable as the second category variable,
      sets, as a plurality of second support variables, a plurality of the indicators other than the support variable and the category variable indicated by the combination determination information, and
      generates auxiliary evaluation information about the support variable by performing processing of generating the evaluation information on the second category variable and the plurality of second support variables.
14. An evaluation method including,
   executing by a computer:
   combination acquisition processing of acquiring combination determination information that determines a combination of a category variable being one of a plurality of indicators related to an evaluation target and at least one support variable each being the indicator different from the category variable; and
   evaluation processing of generating evaluation information indicating an evaluation result of each of a plurality of the support variables by performing processing using the combination determination information, in which
   a plurality of groups are determined based on a value of the category variable, and
   in the evaluation processing, by the computer, for each of the support variables:
      a statistic of the support variable of the group to which a value of the category variable of the evaluation target belongs is acquired; and
      the evaluation information is generated by using the statistic and a value of the support variable of the evaluation target.
15. The evaluation method according to supplementary note 14 described above, in which
   the combination determination information specifies the at least one support variable for each of a plurality of the category variables, and
   in the evaluation processing, by the computer, the evaluation information is generated for each of the category variables.
16. The evaluation method according to supplementary note 14 or 15 described above, in which
   the statistic is an average value, and
   the evaluation information is a value acquired by standardizing a value of the support variable of the evaluation target.
17. The evaluation method according to any one of supplementary notes 14 to 16 described above, further including,
   executing by the computer,
   output processing of outputting, together with the category variable, the support variable in which the evaluation information satisfies a first reference.
18. The evaluation method according to supplementary note 17 described above when dependent on supplementary note 15 described above, in which
   in the evaluation processing, by the computer,
   an evaluation value as the evaluation information is generated for each combination of the category variable and the support variable; and,
   in the output processing, by the computer,
   a combination of the category variable and the support variable in which the evaluation value satisfies the first reference is selected and output.
19. The evaluation method according to supplementary note 18 described above, in which
   places of a plurality of the combinations in ranking are decided according to the evaluation value,
   the first reference is that the place in the ranking is positioned within a first predetermined place when counted from a top, and that the place in the ranking is positioned within a second predetermined place when counted from a bottom, and
   in the output processing, by the computer, each of the combination positioned within the first predetermined place and the combination positioned within the second predetermined place is output.
20. The evaluation method according to supplementary note 18 or 19 described above, in which
   in the output processing, by the computer:
      for each of a plurality of the category variables, the support variable in which the evaluation information satisfies a second reference is selected, and the selected support variable and the category variable are set as a candidate for the combination; and
      the combination needed to be output is selected from among the candidates.
21. The evaluation method according to any one of supplementary notes 17 to 20 described above, in which
   in the output processing, by the computer, the evaluation information is further output.
22. The evaluation method according to any one of supplementary notes 17 to 21 described above, in which
   in the output processing, by the computer,
   the support variable in which the evaluation information does not satisfy a first reference is output when there is a predetermined input.
23. The evaluation method according to any one of supplementary notes 14 to 22 described above, in which
   in the evaluation processing, by the computer,
   the evaluation information is not generated or the evaluation information being fixed is assigned, for the group that satisfies a third reference.
24. The evaluation method according to supplementary note 23 described above, in which
   the third reference is that the group includes at least one of a mode, a medium value, and an average value of the category variables.
25. The evaluation method according to any one of supplementary notes 14 to 24 described above, in which
   at least one support variable is selected for a plurality of the category variables, and
   in the evaluation processing, by the computer:
      the evaluation information is generated for each combination of the category variable and the support variable; and
      comprehensive evaluation information indicating an evaluation result of the evaluation target is generated by using the plurality of pieces of the evaluation information.
26. The evaluation method according to any one of supplementary notes 14 to 25 described above, in which
   in the evaluation processing, by the computer, for each of a plurality of the support variables:
      the support variable is set as the second category variable;
      a plurality of the indicators other than the support variable and the category variable indicated by the combination determination information are set as a plurality of second support variables; and
      auxiliary evaluation information about the support variable is generated by performing processing of generating the evaluation information on the second category variable and the plurality of second support variables.
27. A program causing a computer to include:
   a combination acquisition function of acquiring combination determination information that determines a combination of a category variable being one of a plurality of indicators related to an evaluation target and at least one support variable each being the indicator different from the category variable; and
   an evaluation function of generating evaluation information indicating an evaluation result of each of a plurality of the support variables by performing processing using the combination determination information, in which
   a plurality of groups are determined based on a value of the category variable, and
   the evaluation function, for each of the support variables,
      acquires a statistic of the support variable of the group to which a value of the category variable of the evaluation target belongs, and
      generates the evaluation information by using the statistic and a value of the support variable of the evaluation target.
28. The program according to supplementary note 27 described above, in which
   the combination determination information specifies the at least one support variable for each of a plurality of the category variables, and
   the evaluation function generates the evaluation information for each of the category variables.
29. The program according to supplementary note 27 or 28 described above, in which
   the statistic is an average value, and
   the evaluation information is a value acquired by standardizing a value of the support variable of the evaluation target.
30. The program according to any one of supplementary notes 27 to 29 described above, further causing the computer to include
   an output function of outputting, together with the category variable, the support variable in which the evaluation information satisfies a first reference.
31. The program according to supplementary note 30 described above when dependent on supplementary note 28 described above, in which
   the evaluation function generates an evaluation value as the evaluation information for each combination of the category variable and the support variable, and
   the output function selects and outputs a combination of the category variable and the support variable in which the evaluation value satisfies the first reference.
32. The program according to supplementary note 31 described above, in which
   places of a plurality of the combinations in ranking are decided according to the evaluation value,
   the first reference is that the place in the ranking is positioned within a first predetermined place when counted from a top, and that the place in the ranking is positioned within a second predetermined place when counted from a bottom, and
   the output function outputs each of the combination positioned within the first predetermined place and the combination positioned within the second predetermined place.
33. The program according to supplementary note 31 or 32 described above, in which
   the output function
      selects, for each of a plurality of the category variables, the support variable in which the evaluation information satisfies a second reference, and sets the selected support variable and the category variable as a candidate for the combination, and
      selects the combination needed to be output from among the candidates.
34. The program according to any one of supplementary notes 30 to 33 described above, in which
   the output function further outputs the evaluation information.
35. The program according to any one of supplementary notes 30 to 34 described above, in which
   the output function outputs the support variable in which the evaluation information does not satisfy a first reference when there is a predetermined input.
36. The program according to any one of supplementary notes 27 to 35 described above, in which
   the evaluation function does not generate the evaluation information or assigns the evaluation information being fixed, for the group that satisfies a third reference.
37. The program according to supplementary note 36 described above, in which
   the third reference is that the group includes at least one of a mode, a medium value, and an average value of the category variables.
38. The program according to any one of supplementary notes 27 to 37 described above, in which
   at least one support variable is selected for a plurality of the category variables, and
   the evaluation function
      generates the evaluation information for each combination of the category variable and the support variable, and
      generates comprehensive evaluation information indicating an evaluation result of the evaluation target by using the plurality of pieces of the evaluation information.
39. The program according to any one of supplementary notes 27 to 38 described above, in which
   the evaluation function, for each of a plurality of the support variables,
      sets the support variable as the second category variable,
      sets, as a plurality of second support variables, a plurality of the indicators other than the support variable and the category variable indicated by the combination determination information, and
      generates auxiliary evaluation information about the support variable by performing processing of generating the evaluation information on the second category variable and the plurality of second support variables.

This application is based upon and claims the benefit of priority from Japanese patent application No. 2021-010114, filed on Jan. 26, 2021, the disclosure of which is incorporated herein in its entirety by reference.

### REFERENCE SIGNS LIST

10 Indicator selection apparatus
20 Evaluation apparatus
110 Acquisition unit
120 Selection unit
130 Training data storage unit
140 Combination determination information storage unit
150 Transmission unit
210 Combination acquisition unit
220 Combination storage unit
230 Evaluation unit
240 Target data storage unit
250 Output unit

What is claimed is:

1. An evaluation apparatus comprising:
at least one memory configured to store instructions; and
at least one processor configured to execute the instructions to perform operations, the operations comprising:
acquiring combination determination information that determines a combination of a category variable being one of a plurality of indicators related to an evaluation target and at least one support variable each being the indicator different from the category variable; and
generating evaluation information indicating an evaluation result of each of a plurality of the support variables by performing processing using the combination determination information, wherein
a plurality of groups are determined based on a value of the category variable, and
generating the evaluation information comprises, for each of the support variables,
acquiring a statistic of the support variable of the group to which a value of the category variable of the evaluation target belongs, and
generating the evaluation information by using the statistic and a value of the support variable of the evaluation target.

2. The evaluation apparatus according to claim 1, wherein
the combination determination information specifies the at least one support variable for each of a plurality of the category variables, and
generating the evaluation information comprises generating the evaluation information for each of the category variables.

3. The evaluation apparatus according to claim 1, wherein
the statistic is an average value, and
the evaluation information is a value acquired by standardizing a value of the support variable of the evaluation target.

4. The evaluation apparatus according to claim 1, wherein the operations further comprise
outputting, together with the category variable, the support variable in which the evaluation information satisfies a first reference.

5. The evaluation apparatus according to claim 4 when dependent on claim 2, wherein
generating the evaluation information comprises an evaluation value as the evaluation information for each combination of the category variable and the support variable, and
outputting the support variable comprises selecting and outputting a combination of the category variable and the support variable in which the evaluation value satisfies the first reference.

6. The evaluation apparatus according to claim 5, wherein
places of a plurality of the combinations in ranking are decided according to the evaluation value,
the first reference is that the place in the ranking is positioned within a first predetermined place when counted from a top, and that the place in the ranking is positioned within a second predetermined place when counted from a bottom, and
outputting the support variable comprises outputting each of the combination positioned within the first predetermined place and the combination positioned within the second predetermined place.

7. The evaluation apparatus according to claim 5, wherein
outputting the support variable comprises
selecting, for each of a plurality of the category variables, the support variable in which the evaluation information satisfies a second reference, and
setting the selected support variable and the category variable as a candidate for the combination, and
selecting the combination needed to be output from among the candidates.

8. The evaluation apparatus according to claim 4, wherein
the operations further comprise outputting the evaluation information.

9. The evaluation apparatus according to claim 4, wherein
outputting the support variable comprises outputting the support variable in which the evaluation information does not satisfy a first reference when there is a predetermined input.

10. The evaluation apparatus according to claim 1, wherein
generating the evaluation information comprises not generating the evaluation information or not assigning the evaluation information being fixed, for the group that satisfies a third reference.

11. The evaluation apparatus according to claim 10, wherein
the third reference is that the group includes at least one of a mode, a medium value, and an average value of the category variables.

12. The evaluation apparatus according to claim 1, wherein
at least one support variable is selected for a plurality of the category variables, and
generating the evaluation information comprises
generating the evaluation information for each combination of the category variable and the support variable, and
generating integrated evaluation information indicating an evaluation result of the evaluation target by using the plurality of pieces of the evaluation information.

13. The evaluation apparatus according to claim 1, wherein
generating the evaluation information comprises, for each of a plurality of the support variables,
setting the support variable as the second category variable,
setting, as a plurality of second support variables, a plurality of the indicators other than the support variable and the category variable indicated by the combination determination information, and
generating auxiliary evaluation information about the support variable by performing processing of generating the evaluation information on the second category variable and the plurality of second support variables.

14. An evaluation method comprising,
executing by a computer:
combination acquisition processing of acquiring combination determination information that determines a combination of a category variable being one of a plurality of indicators related to an evaluation target and at least one support variable each being the indicator different from the category variable; and
evaluation processing of generating evaluation information indicating an evaluation result of each of a plurality of the support variables by performing processing using the combination determination information, wherein
a plurality of groups are determined based on a value of the category variable, and
in the evaluation processing, by the computer, for each of the support variables:
a statistic of the support variable of the group to which a value of the category variable of the evaluation target belongs is acquired; and
the evaluation information is generated by using the statistic and a value of the support variable of the evaluation target.

15. The evaluation method according to claim 14, wherein
the combination determination information specifies the at least one support variable for each of a plurality of the category variables, and
in the evaluation processing, by the computer, the evaluation information is generated for each of the category variables.

16. The evaluation method according to claim 14, wherein
the statistic is an average value, and
the evaluation information is a value acquired by standardizing a value of the support variable of the evaluation target.

17. The evaluation method according to claim 14, further comprising,
executing by the computer,
output processing of outputting, together with the category variable, the support variable in which the evaluation information satisfies a first reference.

18-26. (canceled)

27. A non-transitory computer-readable medium storing a program for causing a computer to perform operations, the operations comprising:
acquiring combination determination information that determines a combination of a category variable being one of a plurality of indicators related to an evaluation target and at least one support variable each being the indicator different from the category variable; and
generating evaluation information indicating an evaluation result of each of a plurality of the support variables by performing processing using the combination determination information, wherein
a plurality of groups are determined based on a value of the category variable, and
generating the evaluation information comprises, for each of the support variables,
acquiring a statistic of the support variable of the group to which a value of the category variable of the evaluation target belongs, and
generating the evaluation information by using the statistic and a value of the support variable of the evaluation target.

28. The non-transitory computer-readable medium according to claim 27, wherein
the combination determination information specifies the at least one support variable for each of a plurality of the category variables, and
generating the evaluation information comprises generating the evaluation information for each of the category variables.

29. The non-transitory computer-readable medium according to claim 27, wherein
the statistic is an average value, and
the evaluation information is a value acquired by standardizing a value of the support variable of the evaluation target.

30-39. (canceled)
